(19) United States
(12) Patent Application Publication
(10) Pub. No.: US 2026/0045513 A1
(43) Pub. Date: Feb. 12, 2026

(54) BATTERY AND METHOD OF PRODUCING BATTERY

(71) Applicants: NGK INSULATORS, LTD., Nagoya-City (JP); NAGOYA INSTITUTE OF TECHNOLOGY, Nagoya-City (JP)

(72) Inventors: En YAGI, Nagoya-Shi (JP); Toshihiro YOSHIDA, Nagoya-Shi (JP); Reona MIYAZAKI, Nagoya-Shi (JP)

(73) Assignees: NGK INSULATORS, LTD., Nagoya-City (JP); NAGOYA INSTITUTE OF TECHNOLOGY, Nagoya-City (JP)

(21) Appl. No.: 19/366,617

(22) Filed: Oct. 23, 2025

Related U.S. Application Data
(63) Continuation of application No. PCT/JP2024/019239, filed on May 24, 2024.

(30) Foreign Application Priority Data
May 29, 2023 (JP) 2023-087889
Aug. 29, 2023 (JP) 2023-138734

(51) Int. Cl. H01M 4/62; H01M 4/02; H01M 4/587; H01M 10/0562

(52) U.S. Cl. CPC H01M 4/628; H01M 10/0562; H01M 2004/021; H01M 2004/027; H01M 4/587; H01M 2300/0071

(57) ABSTRACT

A battery includes a positive electrode, a negative electrode that includes a negative active material and a solid electrolyte, and a solid electrolyte layer provided between the positive electrode and the negative electrode. The negative electrode includes another compound that exists at an interface between the negative active material and the solid electrolyte, and the other compound contains Li and O.

### CROSS-REFERENCE TO RELATED APPLICATIONS

The present application is a continuation application of International Application No. PCT/JP2024/019239 filed on May 24, 2024, which claims priority to Japanese Patent Application No. 2023-087889 filed on May 29, 2023 and Japanese Patent Application No. 2023-138734 filed on Aug. 29, 2023. The contents of these applications are incorporated herein by reference in their entirety.

### TECHNICAL FIELD

The present disclosure relates to a battery.

### BACKGROUND ART

With the development of portable equipment such as personal computers and mobile phones in recent years, demand for batteries serving as power sources of such portable equipment is significantly increasing. The batteries used for such purposes conventionally use, as a medium for causing ion migration, an organic electrolyte solution in which an electrolyte dissolves in an inflammable organic solvent. The batteries containing the organic electrolyte solution may cause safety concerns.

To resolve the concerns, the development of all-solid-state batteries using solid electrolytes, instead of organic electrolyte solutions, is advancing in order to ensure intrinsic safety. Since the electrolytes in the all-solid-state batteries are incombustible materials, it is possible to realize lithium (Li) ion batteries with a high degree of intrinsic safety.

Among the solid electrolytes, materials such as sulfide-based materials that react with moisture and generate a hydrogen sulfide gas are widely known. Meanwhile, although oxide-based solid electrolytes that do not generate gases that are for example hydrogen sulfide is also being developed widely, materials for the oxide-based solid electrolytes have lower lithium ion conductivity than materials for the sulfide-based solid electrolytes, and thus it is difficult to improve battery output (or draw a large current).

For example, “Unlocking the Potential of Fluoride-Based Solid Electrolytes for Solid-State Lithium Batteries” by Max Feinauer and other three members (ACS Appl. Energy Mater., 2019, volume 2, pp. 7196-7203) (Document 1) discloses an all-solid-state lithium-ion battery using β-Li₃AlF₆ as a solid electrolyte, and FIG. 5(a) shows charge and discharge curves at 100° C. when Li is used as an anode and LiMn₂O₄ is used as a cathode. The charge and discharge curves show that the second or subsequent charging and discharging capacities are significantly lower than the initial charging and discharging capacities, which results in low cyclic performance. Japanese Patent Application Laid-Open No. 2023-41247 (Document 2) discloses a coated negative active material that includes a Si-based active material and a coating layer, the coating layer containing a lithium oxide and coating at least part of the surface of the Si-based active material.

International Publication No. 2022/210482 (Document 3) discloses a solid electrolyte composed primarily of a component expressed by Li_{a+d}M_{b}X_{c}AₑO_{f}, where M is an element serving as a trivalent cation, X is a halogen element, and A is a sulfur or phosphorus element. In “Interface Stability in Solid-State Batteries,” by William D. Richards and other four members (ACS Chem. Mater., 2016, volume 28, pp. 266-273) (Document 4), FIG. 2 shows electrochemical stability ranges of various solid electrolyte materials.

As described previously, the battery according to Document 1 exhibits low cyclic performance. This battery exhibits low cyclic performance even in the case where the inventors of the present application have conducted an experiment by changing the electrodes of the battery into an NCM positive electrode and a graphite negative electrode. The battery also exhibits low Coulomb efficiency (capacity ratio between charge and discharge) and a low discharge capacity during initial charge and discharge. Accordingly, there is demand for batteries with high Coulomb efficiency and high cyclic performance.

### SUMMARY OF THE INVENTION

It is an object of the present disclosure to provide a battery with high Coulomb efficiency and high cyclic performance.

Aspect 1 of the present disclosure is a battery that includes a positive electrode, a negative electrode including a negative active material and a solid electrolyte, and a solid electrolyte layer provided between the positive electrode and the negative electrode. The negative electrode includes another compound that exists at an interface between the negative active material and the solid electrolyte, and the another compound contains Li and O.

According to the present disclosure, it is possible to provide the battery with high Coulomb efficiency and high cyclic performance.

Aspect 2 of the present disclosure is the battery according to Aspect 1, in which the negative active material is an active material that operates at a potential of less than or equal to 2.0V (vs. Li/Li⁺).

Aspect 3 of the present disclosure is the battery according to Aspect 1 or 2, in which the negative active material is an active material that operates at a potential of less than or equal to 1.0V (vs. Li/Li⁺).

Aspect 4 of the present disclosure is the battery according to any one of Aspects 1 to 3, in which the another compound exists as a layer at the interface, and the another compound has a thickness of 1 nm to 1000 nm.

Aspect 5 of the present disclosure is the battery according to any one of Aspects 1 to 4, in which the solid electrolyte contains Li and O.

Aspect 6 of the present disclosure is the battery according to Aspect 5, in which the solid electrolyte further contains X that is a halogen element.

Aspect 7 of the present disclosure is the battery according to Aspect 5 or 6, in which the solid electrolyte further contains S.

Aspect 8 of the present disclosure is the battery according to any one of Aspects 5 to 7, in which the solid electrolyte further contains Al.

Aspect 9 of the present disclosure is the battery according to any one of Aspects 5 to 8, in which the solid electrolyte contains, as a principal component, a component expressed by a composition formula of Li_{a+d}M_{b}X_{c}SₑO_{f} with values a to f being greater than zero, where M is an element serving as a trivalent cation, and X is a halogen element, and 0.8c≤(a+3b)≤1.2c and 1.6f≤(d+n×e)≤2.4f are satisfied, where n is four or six.

Aspect 10 of the present disclosure is the battery according to any one of Aspects 1 to 9, in which the another compound does not contain Ti.

Aspect 11 of the present disclosure is the battery according to any one of Aspects 1 to 10, in which the solid electrolyte contains S, and the another compound does not contain S.

Aspect 12 of the present disclosure is the battery according to any one of Aspects 1 to 11, in which the negative active material is carbon.

The present disclosure is also intended for a method of producing a battery.

Aspect 13 of the present disclosure is a method of producing the battery according to any one of Aspects 1 to 12. The method includes a) preparing a battery by stacking a positive electrode, a solid electrolyte layer, and a negative electrode that includes a negative active material and a solid electrolyte, and b) performing a charge operation on the battery. The solid electrolyte of the negative electrode contains Li and O.

Aspect 14 of the present disclosure is a method of producing the battery according to any one of Aspects 1 to 12. The method includes a) preparing a battery by stacking a positive electrode, a solid electrolyte layer, and a negative electrode that includes a negative active material and a solid electrolyte, and b) performing a charge operation on the battery. The operation a) is performed in an oxygen-containing atmosphere, and in the operation b), Li ions migrate from the positive electrode to the negative electrode.

These and other objects, features, aspects and advantages of the present disclosure will become more apparent from the following detailed description of the present disclosure when taken in conjunction with the accompanying drawings.

### BRIEF DESCRIPTION OF DRAWINGS

FIG. 1 is a longitudinal sectional view showing an all-solid-state battery.

FIG. 2 is a diagram schematically showing a section of a negative electrode layer.

FIG. 3 is a flowchart of production of the all-solid-state battery.

FIG. 4 is a diagram showing the results of a charge and discharge test conducted on an all-solid-state battery according to Experiment 1.

FIG. 5 is a diagram showing the results of a charge and discharge test conducted on an all-solid-state battery according to Experiment 2.

FIG. 6 is a diagram showing the results of analyses of a section of a negative electrode conducted with an FE-SEM/EDX on the all-solid-state battery according to Experiment 2 after charge and discharge.

FIG. 7 is a diagram showing the results of analyses of a section of the negative electrode conducted with an FE-SEM/EDX on the all-solid-state battery according to Experiment 2 before charge and discharge.

FIG. 8 is a diagram showing the results of analyses of the section of the negative electrode by AES conducted on the all-solid-state battery according to Experiment 2 after charge and discharge.

### DETAILED DESCRIPTION

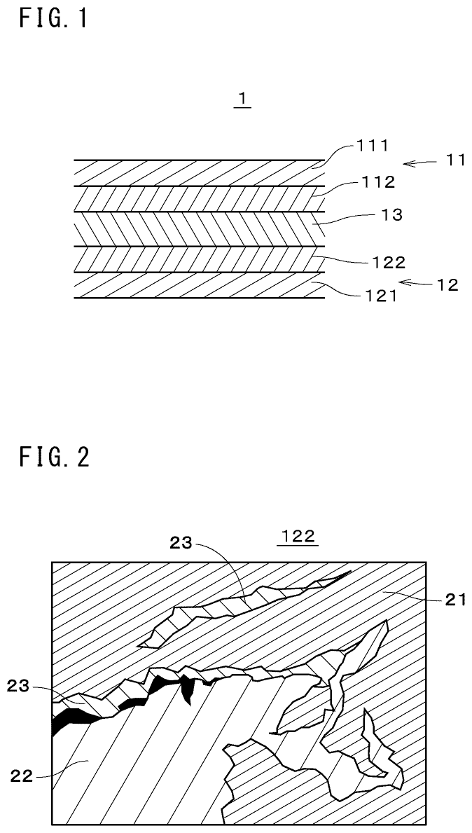

FIG. 1 is a longitudinal sectional view showing an all-solid-state battery 1. The all-solid-state battery 1 according to the present embodiment is an all-solid-state lithium-ion battery and is a chargeable and dischargeable secondary battery. The all-solid-state battery 1 includes a positive electrode 11, a solid electrolyte layer 13, and a negative electrode 12 in order from the top in FIG. 1. The solid electrolyte layer 13 is provided between the positive electrode 11 and the negative electrode 12. The solid electrolyte layer 13 also serves as a separator layer. The solid electrolyte layer 13 is composed of or includes a solid electrolyte 22 which will be described later.

The positive electrode 11 includes a current collector 111 and a positive electrode layer 112. The positive electrode layer 112 is in contact with the solid electrolyte layer 13 and includes a positive active material. The positive active material of the positive electrode layer 112 preferably contains a lithium complex oxide. A preferable positive active material is a lithium complex oxide having a layered rock-salt structure and may, for example, be NCM (Li(Ni, Co, Mn)O₂). The positive active material may be any other lithium complex oxide and may, for example, be NCA (Li(Ni, Co, Al)O₂) or LCO (LiCoO₂) having a layered rock-salt structure, LNMO (Li(Ni, Mn)O₄) having a spinel structure, or LFP (LiFePO₄) having an olivine structure. In addition to the positive active material, the positive electrode layer 112 further includes the solid electrolyte 22 described later. The positive electrode layer 112 may further include an electron conductive agent (e.g., carbon black). One example of the positive electrode layer 112 is obtained by integrating those substances together by the application of pressure or heat.

The current collector 111 is arranged on the positive electrode layer 112 at the side opposite to the solid electrolyte layer 13, and is in contact with the positive electrode layer 112. For example, the current collector 111 may be formed of copper, stainless steel, nickel, aluminum, silver, gold, chromium, iron, tin, lead, tungsten, molybdenum, titanium, zinc, or an alloy that contains any of these substances. The same also applies to a current collector 121 of the negative electrode 12, which will be described later.

The negative electrode 12 includes the current collector 121 and a negative electrode layer 122. The negative electrode layer 122 is in contact with the solid electrolyte layer 13 and includes a negative active material 21 and a solid electrolyte 22 which will be described later. The negative electrode layer 122 may further include an electron conductive agent (e.g., carbon black). One example of the negative electrode layer 122 is configured by integrating those substances together by the application of pressure or heat. The current collector 121 is arranged on the negative electrode layer 122 at the side opposite to the solid electrolyte layer 13, and is in contact with the negative electrode layer 122.

FIG. 2 is a diagram schematically showing a section of the negative electrode layer 122, and shows an interface between the negative active material 21 and the solid electrolyte 22, and an area in the vicinity of the interface. The negative active material 21 may, for example, be carbon (C) and is preferably graphite. The negative active material 21 is preferably an active material that operates at a potential of less than or equal to 2.0V (vs. Li/Li⁺). The potential at which the negative active material 21 operates is more preferably less than or equal to 1.5V (vs. Li/Li⁺) and yet more preferably less than or equal to 1.0V (vs. Li/Li⁺). Instead of graphite, the negative active material 21 may also be hard carbon, SiO (silicon monoxide), Si (silicon) metal, an Si-containing alloy, Sn (tin) metal, a Sn-containing alloy, Li metal, or a Li-containing alloy.

The negative active material 21 has a particle diameter of, for example, 5 μm to 20 μm. For example, the particle diameter of the negative active material 21 can be measured by observing a mirror-polished section of the negative electrode with a SEM (scanning electron microscope) and computing a mean major axis of particles of the negative active material 21.

The solid electrolyte 22 is a lithium-ion conductive material. For example, the solid electrolyte 22 contains Li and O (oxygen). The solid electrolyte 22 may further contain at least one element selected from among a halogen element X, S (sulfur), and Al (aluminum). Alternatively, the solid electrolyte 22 may contain all of X, S, and Al.

A preferable example of the solid electrolyte 22 contains, as a primary component, a component expressed by a composition formula of Li_{a+d}M_{b}X_{c}SₑO_{f} with values a to f being greater than zero, where M is an element serving as a trivalent cation, and X is a halogen element, as disclosed in International Publication No. 2022/210482 (Document 3 described above). This composition formula satisfies 0.8c≤(a+3b)≤1.2c and 1.6f≤(d+n×e)≤2.4f, where n is four or six. The solid electrolyte 22 exhibits high lithium-ion conductivity and high temperature stability. Besides, this solid electrolyte generates no hydrogen sulfide gases, thus achieving high safety. The principal component as used herein refers to a component that has a highest mass ratio among all components included in the solid electrolyte 22. The mass ratio of the principal component in the solid electrolyte 22 is preferably higher than or equal to 80% by mass and more preferably higher than or equal to 90% by mass.

One example of the solid electrolyte 22 according to the present embodiment is a mixture of Li₃AlF₆ that contains Li, Al, and F (fluorine) and Li₂SO₄ (lithium sulfate) that contains Li, S, and O. The solid electrolyte 22 containing Li₃AlF₆ and Li₂SO₄ exhibits higher lithium-ion conductivity than a simple substance of Li₃AlF₆. The reason for this is not clear, but one conceivable reason is that a mechanical milling process performed in the making of the solid electrolyte 22, which will be described later, forms an interfacial layer having high lithium-ion conductivity at a particle interface between Li₃AlF₆ and Li₂SO₄. The same applies to cases where the solid electrolyte 22 is a mixture of other substances such as Li₃AlF₆ and LiPO₃.

For example, a particle diameter of the solid electrolyte 22 is smaller than a particle diameter of the negative active material 21. The particle diameter of the solid electrolyte 22 is also, for example, less than or equal to 5 μm, preferably less than or equal to 4.5 μm, and more preferably less than or equal to 4 μm. Such a sufficiently small particle diameter of the solid electrolyte 22 narrows interstices at the interface between the negative active material 21 and the solid electrolyte 22 and allows the negative active material 21 and the solid electrolyte 22 to adhere more easily to each other. This results in an increase in the discharge capacity of the all-solid-state battery 1 and allows appropriate generation of an interfacial product 23 described later. Although there is no particular lower limit on the particle diameter of the solid electrolyte 22, the lower limit is, for example, 0.3 μm, preferably 0.5 μm, and more preferably 1 μm. For example, the particle diameter of the solid electrolyte 22 can be measured by observing a mirror-polished section of the negative electrode with a SEM (scanning electron microscope) and obtaining a mean major axis of particles of the solid electrolyte 22.

As shown in FIG. 2, the negative electrode layer 122 includes the other compound 23 that exists at the interface between the negative active material 21 and the solid electrolyte 22. The compound 23 is included in neither the negative active material 21 nor the solid electrolyte 22 and contains Li and O. As will be described later, the other compound 23 is produced by performing a charge operation on the all-solid-state battery 1 and is thus referred to as the “interfacial product 23” in the following description.

The interfacial product 23 is typically an oxide that contains Li (oxide of Li) and is preferably Li₂O (lithium oxide). The interfacial product 23 may further contain other elements in addition to Li and O and is not limited to Li₂O. In the case where the solid electrolyte 22 contains at least one element selected from among X (halogen element), S, and Al, the interfacial product 23 may contain any of the at least one element, or may not contain any of the at least one element. In other words, in the case where the solid electrolyte 22 contains X, the interfacial product 23 may or may not contain X. In the case where the solid electrolyte 22 contains S, the interfacial product 23 may or may not contain S. In the case where the solid electrolyte 22 contains Al, the interfacial product 23 may or may not contain Al. In the case where the negative active material 21 is carbon, it is preferable that the interfacial product 23 does not contain C. The interfacial product 23 also does not contain Ti (titanium), which is often used as a constituent element of the negative active material.

Typically, the interfacial product 23 exists as a layer at the interface between the negative active material 21 and the solid electrolyte 22. The interfacial product 23 may exist at a position slightly away from that interface. In the specification of the present disclosure, a phrase saying “the interfacial product 23 exists at the interface between the negative active material 21 and the solid electrolyte 22” refers not only to the case where the interfacial product 23 exists at the interface in a strict sense, but also to cases where the interfacial product 23 exists in the vicinity of that interface. For example, if the shortest distance between the interfacial product 23 and the interface is less than or equal to 1 μm, it can be said that the interfacial product 23 exists in the vicinity of the interface. In the all-solid-state battery 1 in which the interfacial product 23 exists at the interface between the negative active material 21 and the solid electrolyte 22, it is conceivable that the interfacial product 23 functions as a decomposition inhibiting layer during charge, the decomposition inhibiting layer inhibiting reduction decomposition of the solid electrolyte 22. As a result, high Coulomb efficiency and high cyclic performance are achieved.

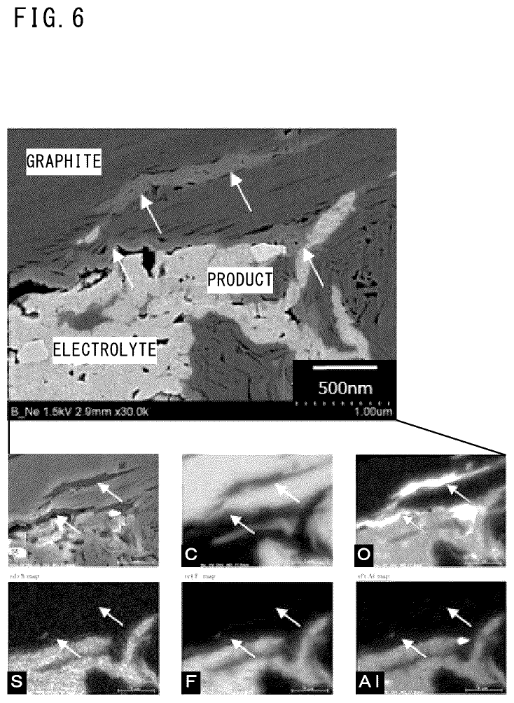

The interfacial product 23 as a layer has a thickness of, for example, greater than or equal to 1 nm, preferably greater than or equal to 10 nm, and more preferably greater than or equal to 30 nm. In this case, it is possible to more reliably inhibit reduction decomposition of the solid electrolyte 22. The thickness of the interfacial product 23 is also, for example, less than or equal to 1000 nm, preferably less than or equal to 750 nm, and more preferably less than or equal to 500 nm. In this case, it is possible to prevent deterioration in the conductivity of the negative electrode 12. As will be described later, the thickness of the interfacial product 23 can be measured by obtaining a mean maximum thickness of respective layers that have higher O concentrations than the solid electrolyte 22 in a mapping image of the O (oxygen) element (see the lower section of FIG. 6 described later) obtained with an EDX (energy dispersive X-ray spectroscope) from the mirror-polished section of the negative electrode. Depending on the design or the like of the all-solid-state battery 1, the thickness of the interfacial product 23 may be less than 1 nm, or may be greater than 1000 nm.

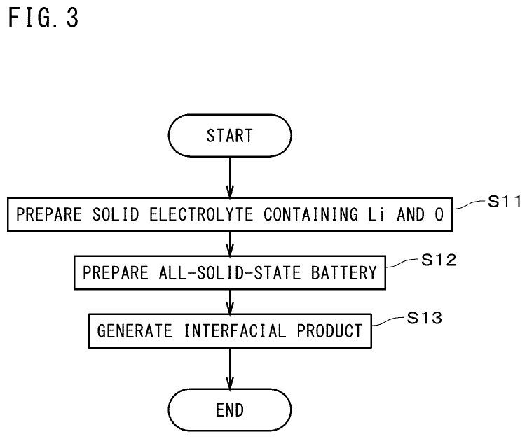

FIG. 3 is a flowchart of the production of the all-solid-state battery 1. The production of the all-solid-state battery 1 is conducted in, for example, an oxygen-containing atmosphere such as a dry room controlled at a dew point of −40° C. or less. In the production of the all-solid-state battery 1, firstly, the solid electrolyte 22 is prepared, which is used in the positive electrode 11, the solid electrolyte layer 13, and the negative electrode 12 (step S11). For example, the solid electrolyte 22 contains Li and O, and the solid electrolyte 22 according to the present processing example is made by mixing Li₃AlF₆ and Li₂SO₄. The solid electrolyte 22 is however not limited to being made by mixing Li₃AlF₆ and Li₂SO₄. Moreover, the solid electrolyte 22 does not necessarily have to contain O.

In the making of the solid electrolyte 22, Li₃AlF₆ powder and Li₂SO₄ powder are prepared. In the preparation of the Li₃AlF₆ powder, for example, commercial LiF (lithium fluoride) powder and commercial AlF₃ (aluminum fluoride) powder are weighed and mixed together. Then, a resultant mixture is subjected to heat treatment (at, for example, 900° C.) and then pulverized into the Li₃AlF₆ powder. The Li₃AlF₆ powder may be generated by any other technique. The Li₂SO₄ powder is commercially available. It is of course possible to generate the Li₂SO₄ powder by any known technique.

Then, the Li₃AlF₆ powder and the Li₂SO₄ powder are mixed together. The ratio of the amount of substance of Li₂SO₄ in the total of the amounts of substances of Li₃AlF₆ and Li₂SO₄ is in the range of, for example, 5% to 85%. Thereafter, a resultant mixture is subjected to a mechanical milling process (mechanochemical milling). In one example of the mechanical milling process, a planetary ball mill may be used. In the planetary ball mill, a stage with a pot placed thereon revolves while the pot rotates on its axis, so that remarkably high impact energy can be generated. The mechanical milling process may use any other type of pulverizer. Through the mechanical milling process described above, Li₃AlF₆—Li₂SO₄ powder is obtained as the solid electrolyte 22. In the present processing example, the mechanical milling process is conducted at ordinary temperatures, but conditions such as temperature may be appropriately changed.

After the powder of the solid electrolyte 22 has been made, a layered body of the positive electrode layer 112, the solid electrolyte layer 13, and the negative electrode layer 122 is made. The positive electrode layer 112 is made by mixing powder of a positive active material with the powder of the solid electrolyte 22 and subjecting the resultant powder to pressure molding. The positive electrode layer 112 may be further mixed with an electron conductive agent. Typically, the particle diameter of the electron conductive agent is sufficiently smaller than those of the powder of the positive active material and the powder of the solid electrolyte 22 (the same can be said in the making of the negative electrode layer 122). The negative electrode layer 122 is made by mixing powder of the negative active material 21 with the powder of the solid electrolyte 22 and subjecting the resultant powder to pressure molding. The particle diameter of the negative active material 21 is in the range of, for example, 5 μm to 20 μm, and the particle diameter of the solid electrolyte 22 is in the range of, for example, 0.3 μm to 5 μm. The negative electrode layer 122 may be further mixed with an electron conductive agent. The solid electrolyte layer 13 is made by subjecting the powder of the solid electrolyte 22 to pressure molding. Alternatively, the positive electrode layer 112, the solid electrolyte layer 13, and the negative electrode layer 122 maybe integrally subjected to pressure molding. Thereafter, the current collector 111 is mounted on the positive electrode layer 112, and the current collector 121 is mounted on the negative electrode layer 122. In this way, the all-solid-state battery 1 including the positive electrode 11, the solid electrolyte layer 13, and the negative electrode 12 is made and prepared (step S12). The positive electrode layer 112, the solid electrolyte layer 13, and the negative electrode layer 122 may be placed in a sealed case.

After the all-solid-state battery 1 has been prepared, the current collectors 111 and 121 are connected to a power source, and a charge operation is performed on the all-solid-state battery 1. Accordingly, in the negative electrode 12, another compound that contains Li and O, i.e., the interfacial product 23, is generated at the interface between the negative active material 21 and the solid electrolyte 22 (step S13). The reason why the interfacial product 23 is generated is not clear, but a conceivable reason is that, for example, in the case where the solid electrolyte 22 is Li₃AlF₆—Li₂SO₄ powder, Li₂O is generated by a reaction expressed by Expression (1) given later. Another possibility is that an O₂ gas mixed with the negative electrode 12 in the making of the all-solid-state battery 1 reacted with Li ions. Through the processing described above, the production of the all-solid-state battery 1 is completed. In the case where the positive electrode layer 112, the solid electrolyte layer 13, and the negative electrode layer 122 are placed in a case, step S13 may be performed in the air.

Next, experiments of the all-solid-state battery 1 will be described. Table 1 shows configurations of all-solid-state batteries according to Experiments 1 to 4 and the results of a charge and discharge test. Experiment 1 is a comparative example, and Experiments 2 to 4 are examples of the present disclosure. The following experiment was conducted in a glove box or a dry room controlled at a dew point of −40° C. or less.

TABLE 1

| | | | | Charge and Discharge | | |
|---|---|---|---|---|---|---|
| | Configuration of | | | Initial | Initial | Three-Cycle |
| | All-Solid-State Battery | | | Discharge | Coulomb | Capacity |
| | Positive | Negative | | Amount | Efficiency | Retention Rate |
| | Electrode | Electrode | Solid Electrolyte | (mAh/g) | (%) | (%-Initial Ratio) |
| Experiment 1 | NCM | Graphite | Li₃AlF₆ | 28 | 15 | 57 |
| Experiment 2 | NCM | Graphite | Li₃AlF₆—Li₂SO₄ | 110 | 74 | 99 |
| Experiment 3 | NCM | Graphite | Li₃AlF₆—Li₂SO₄—Li₂SiF₆ | 120 | 83 | 90 |
| Experiment 4 | NCM | Graphite | Li₃AlF₆—LiPO₃ | 56 | 32 | 77 |

### Experiment 1

Commercial LiF powder and commercial AlF₃ powder were prepared as raw materials. These raw materials were weighed and mixed together in a ratio LiF:AlF₃ of 3:1 (molar ratio). A resultant mixture was subjected to heat treatment at 900° C. and thereafter pulverized in a mortar into Li₃AlF₆ powder that served as solid electrolyte powder in Experiment 1.

Positive active material powder that was NCM:Li(Ni, Co, Mn)O₂, the solid electrolyte powder (Li₃AlF₆ powder), and electron conductive agent powder were weighed and mixed together into blended powder of the positive electrode. Also, negative active material powder that was graphite, the solid electrolyte powder, and electron conductive agent powder were weighed and mixed together into blended powder of the negative electrode. The solid electrolyte powder was poured into a mold configured by a PEEK resinous sleeve and upper and lower punches of SUS and subjected to uniaxial press molding by the application of pressure at 150 MPa.

The blended powder of the positive electrode was poured onto the pressed solid electrolyte powder and integrated with the solid electrolyte powder by the application of pressure at 150 MPa. The blended powder of the negative electrode was poured onto the pressed solid electrolyte powder on the side opposite to the positive electrode and was integrated with the solid electrolyte powder by the application of pressure at 150 MPa. In this way, the all-solid-state battery configured by the positive electrode layer, the solid electrolyte layer, and the negative electrode layer was made.

### Experiment 2

Commercial Li₂SO₄ powder was prepared, in addition to the Li₃AlF₆ powder described above. The Li₃AlF₆ powder and the Li₂SO₄ powder were weighed in a molar ratio of 1:1 and subjected to a mechanical milling process using a planetary ball mill so as to obtain Li₃AlF₆—Li₂SO₄ powder. Thereafter, the all-solid-state battery was made through the same processing as in Experiment 1, except that the Li₃AlF₆—Li₂SO₄ powder was used as the solid electrolyte powder.

### Experiment 3

Commercial Li₂SiF₆ powder was prepared, in addition to the Li₃AlF₆ powder and the Li₂SO₄ powder described above. The Li₃AlF₆ powder, the Li₂SO₄ powder, and the Li₂SiF₆ powder were weighed in a molar ratio of 8:2:1 and subjected to a mechanical milling process using a planetary ball mill so as to obtain Li₃AlF₆—Li₂SO₄—Li₂SiF₆ powder. Thereafter, the all-solid-state battery was made through the same processing as in Experiment 1, except that the Li₃AlF₆—Li₂SO₄—Li₂SiF₆ powder was used as the solid electrolyte powder.

### Experiment 4

Commercial LiPO₃ powder was prepared, in addition to the Li₃AlF₆ powder described above. The Li₃AlF₆ powder and the LiPO₃ powder were weighed in a molar ratio of 9:1 and subjected to a mechanical milling process using a planetary ball mill so as to obtain Li₃AlF₆—LiPO₃ powder. Thereafter, the all-solid-state battery was made through the same processing as in Experiment 1, except that the Li₃AlF₆—Li PO₃ powder was used as the solid electrolyte powder.

### Charge and Discharge Test

A cc-cv (constant current-constant voltage) charge and discharge test was conducted, with the upper and lower punches connected to conductors and the all-solid-state battery described above resting in a temperature controlled chamber controlled at 100° C. In the charge and discharge test, it was assumed that the cc current density was 300 μA/cm², the cv current density was 30 μA/cm², and the cutoff voltage was 4.15-2.00V.

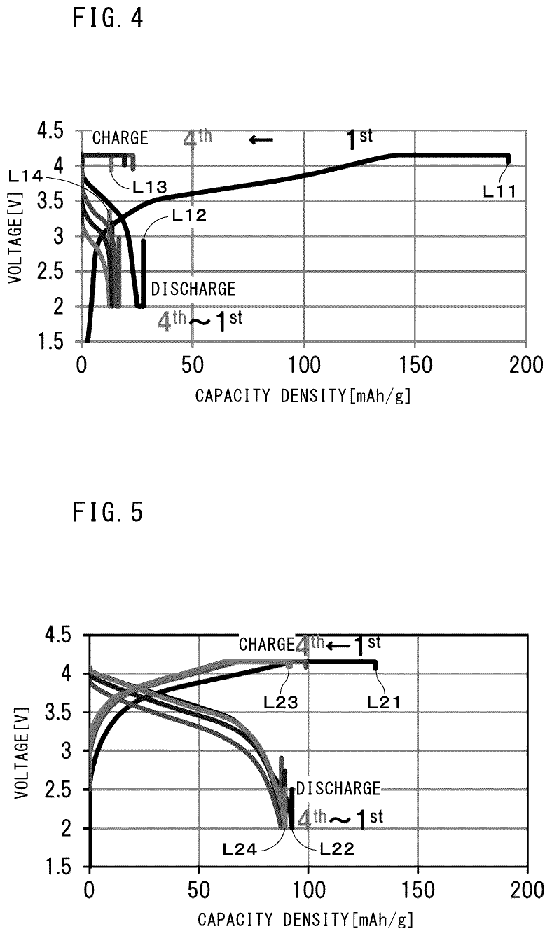

FIG. 4 is a diagram showing the results of the charge and discharge test conducted on the all-solid-state battery according to Experiment 1, and FIG. 5 is a diagram showing the results of the charge and discharge test conducted on the all-solid-state battery according to Experiment 2. In FIGS. 4 and 5, initial charge curves are denoted respectively by L11 and L21, initial discharge curves are denoted respectively by L12 and L22, fourth charge curves are denoted respectively by L13 and L23, and fourth discharge curves are denoted respectively by L14 and L24. In Table 1, the discharge capacity during initial discharge is shown in the “Initial Discharge Amount” field, Coulomb efficiency (discharge capacity/charge capacity) during initial charge and discharge is shown in the “Initial Coulomb Efficiency” field, and the ratio of the fourth discharge capacity to the initial discharge capacity is shown in the “Three-Cycle Capacity Retention Rate” field.

As is clear from FIGS. 4 and 5 and Table 1, the all-solid-state batteries according to Experiments 2 to 4 exhibited higher initial discharge capacity and higher Coulomb efficiency than the all-solid-state battery according to Experiment 1. The all-solid-state batteries according to Experiments 2 to 4 also exhibited high three-cycle capacity retention rate, and accordingly it was confirmed that the all-solid-state batteries according to Experiments 2 to 4 exhibited higher cyclic performance than the all-solid-state battery according to Experiment 1.

Analysis of Interface in Negative Electrode of all-Solid-State Battery

Here, the all-solid-state battery according to Experiment 2 that had been neither charged nor discharged was defined as the all-solid-state battery before charge and discharge, and the all-solid-state battery according to Experiment 2 that had been charged and discharged was defined as the all-solid-state battery after charge and discharge. Then, a mirror-polished section of the negative electrode in each of the all-solid-state batteries before and after charge and discharge was observed with an FE-SEM (field emission scanning electron microscope). This section was also subjected to element mapping with an EDX (energy dispersive X-ray spectroscope).

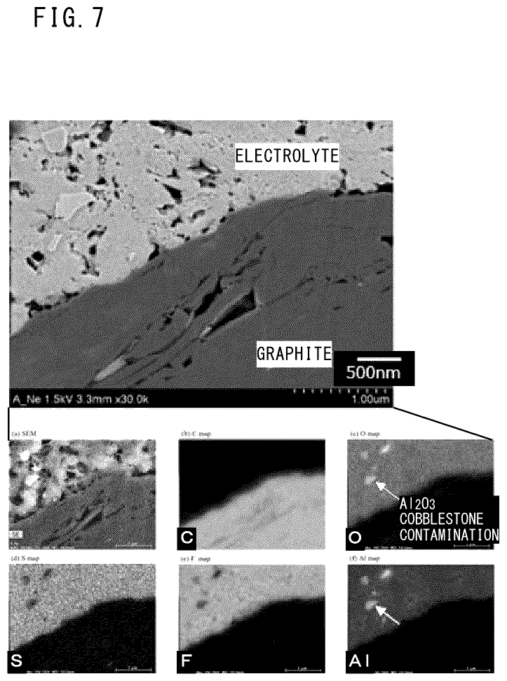

FIGS. 6 and 7 are diagrams showing the results of analyses of the section of the negative electrode conducted with the FE-SEM/EDX. FIG. 6 shows the results of analyses conducted on the all-solid-state battery according to Experiment 2 after charge and discharge, and FIG. 7 shows the results of analyses conducted on the all-solid-state battery according to Experiment 2 before charge and discharge. The upper sections of FIGS. 6 and 7 show images observed with the FE-SEM. The lower sections of FIGS. 6 and 7 show the results of the element mapping of C, O, S, F, and Al, in which a higher concentration of white color showed a higher concentration of each element.

In the all-solid-state battery after charge and discharge shown in FIG. 6, the presence of an oxide layer that contained O and that did not contain C, S, F, and Al was confirmed at the interface between the negative active material containing C and the solid electrolyte containing 0, S, F, and Al. In FIG. 6, the positions of the oxide layer (product) are indicated by white arrows. Note that the thickness of the oxide layer was in the range of 1 nm to 1000 nm. On the other hand, in the all-solid-state battery before charge and discharge shown in FIG. 7, the presence of the oxide layer (i.e., the oxide layer that contained 0 and did not contain C, S, F, and Al) was not confirmed. In FIG. 7, contamination of fragments of an Al₂O₃ cobblestone that was used in the making of the solid electrolyte powder was confirmed, and the positions of these fragments were denoted as “Al₂O₃ cobblestone contamination.”

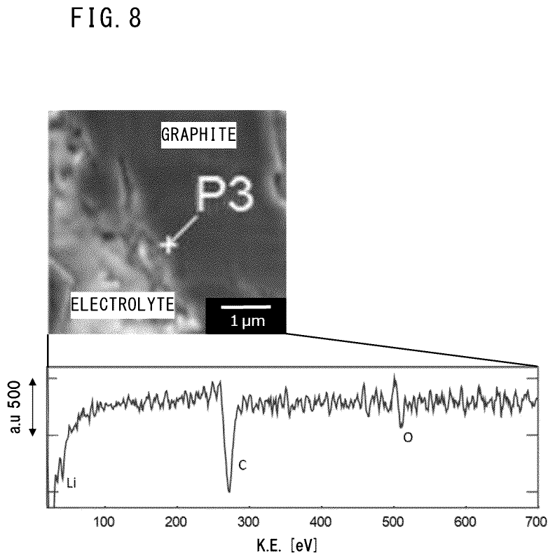

Then, the mirror-polished section of the negative electrode of the all-solid-state battery after charge and discharge was analyzed by AES (Auger electron spectroscopy). FIG. 8 is a diagram showing the results of the analysis conducted on the section of the negative electrode by AES. In FIG. 8, the upper section shows an image of the section of the negative electrode, and the lower section shows an Auger electron spectrum at the position denoted by a reference sign P3 in the image shown in the upper section. The position P3 corresponds to the oxide layer described above, and the presence of Li was confirmed at the position P3. Therefore, it can be said that the oxide layer contained Li and thus was a compound (interfacial product) that contained Li and O. In the all-solid-state barriers according to Experiments 3 and 4, the presence of such a compound (interfacial product) containing Li and O was also confirmed at the interface between the negative active material and the solid electrolyte after charge and discharge.

### Consideration 1 of Interfacial Product

It is conceivable that the above-described compound (interfacial product) containing Li and O was generated as a reduction product at the interface between the negative active material and the solid electrolyte as a result of reduction decomposition of some components (e.g., Li₂SO₄) contained in the solid electrolyte of the negative electrode during charge of the all-solid-state battery. In the case where the solid electrolyte contains Li₂SO₄, a conceivable reduction reaction that could occur in the negative electrode during charge during which Li and electrons were supplied from the positive electrode was as expressed by Expression (1) below:

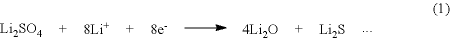

In the compound (Li₂O) containing Li and O according to the example described above, reduction decomposition will not occur even if a negative active material having a low operating potential (e.g., an operating potential of less than or equal to 2.0V (vs. Li/Li⁺) and preferably less than or equal to 1.0 V (vs. Li/Li⁺)) is used (see FIG. 2 of “Interface Stability in Solid-State Batteries” by William D. Richards and other four members (ACS Chem. Mater., 2016, volume 28, pp. 266-273) (Document 4 described above)). Besides, the compound becomes passive state with no conductivity. Accordingly, it is conceivable that the intervention of this compound at the interface between the negative active material and the solid electrolyte allows the compound to function as a decomposition inhibiting layer that inhibits reduction decomposition of the solid electrolyte. As a result, it is possible to stably charge and discharge the all-solid-state battery while using the negative active material having a low operating potential, thereby achieving high Coulomb efficiency and high cyclic performance. The solid electrolyte does not necessarily have to contain Li₂SO₄, and it is possible to use any solid electrolyte that generates another compound that contains Li and O at the interface with the negative active material by the charge operation. Typically, it is conceivable that the above-described compound (interfacial product) containing Li and O is generated by using a solid electrolyte that contains Li and O and a negative active material that has an operating potential of less than or equal to 2.0V (vs. Li/Li⁺) (preferably less than or equal to 1.0V (vs. Li/Li⁺)).

### Consideration 2 of Interfacial Product

Depending on various conditions or the like, it is also conceivable that the compound (Li₂O) containing Li and O is generated as a result of Li⁺ ions and electrons e⁻ in the negative electrode that have migrated from the positive electrode reacting with an O₂ gas contained in the negative electrode (O₂ gas mixed in the negative electrode in the making of the all-solid-state battery) during charge of the all-solid-state battery as expressed by Expression (2) given below. This can be caused by, for example, making (and charging and discharging) the all-solid-state battery in a dry room controlled at a dew point of −40° C. or less. Accordingly, it is conceivable that the above-described compound (interfacial product) containing Li and O is generated even if the solid electrolyte does not contain any other compound containing O such as Li₂SO₄, i.e., does not contain an O element.

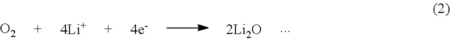

As described thus far, the all-solid-state battery 1 includes the positive electrode 11, the negative electrode 12 that includes the negative active material 21 and the solid electrolyte 22, and the solid electrolyte layer 13 provided between the positive electrode 11 and the negative electrode 12. The negative electrode 12 includes another compound that exists at the interface between the negative active material 21 and the solid electrolyte 22, and the other compound contains Li and O. The all-solid-state battery 1 as described above is capable of inhibiting continuous reduction decomposition of the solid electrolyte 22 in the presence of the other compound, thereby achieving high Coulomb efficiency and high cyclic performance.

Preferably, the other compound exists as a layer at the above-described interface and has a thickness of 1 nm to 1000 nm. The other compound with a thickness of greater than or equal to 1 nm more reliably inhibits reduction decomposition of the solid electrolyte 22. Besides, the other compound with a thickness of less than or equal to 1000 nm prevents deterioration in the conductivity of the negative electrode 12.

Preferably, the negative active material 21 is an active material that operates at a potential of less than or equal to 2.0V (vs. Li/Li⁺), and more preferably the negative active material 21 is an active material that operates at a potential of less than or equal to 1.0V (vs. Li/Li⁺). This allows the other compound to be generated more reliably by the charge operation of the all-solid-state battery 1. Since the solid electrolyte 22 contains Li and O, it is possible to generate the other compound by temporal reduction decomposition of the solid electrolyte 22.

A preferable method of producing the all-solid-state battery 1 described above includes the step of preparing a battery by stacking the positive electrode 11, the solid electrolyte layer 13, and the negative electrode 12 that includes the negative active material 21 and the solid electrolyte 22 (step S12), and the step of performing a charge operation on the battery (step S13). The solid electrolyte 22 of the negative electrode 12 contains Li and O. Alternatively, step S12 may be performed in an oxygen-containing atmosphere, and in step S13, Li ions migrate from the positive electrode 11 to the negative electrode 12. This allows the other compound containing Li and O to be generated easily at the interface between the negative active material 21 and the solid electrolyte 22 in the negative electrode 12.

In the above-described embodiment, the solid electrolyte 22 is obtained by subjecting Li₃AlF₆ and Li₂SO₄ to a mechanical milling process, but the solid electrolyte 22 may be produced by mixing compounds LiₐM_{b}X_{c} and Li_{d}SₑO_{f}, the compound LiₐM_{b}X_{c} containing Li, a metallic element M serving as a trivalent cation, and a halogen element X, the compound Li_{d}SₑO_{f} containing Li, S, and O, where a to f are values greater than zero. Here, Li, M, and X serve respectively as a univalent cation, a trivalent cation, and a univalent anion. Thus, a+3b=c is satisfied. The compound LiₐM_{b}X_{c} described above may, for example, be Li₃YF₆, Li₃LaF₆, Li₃GaF₆, Li₃YCl₆, Li₃YBr₆, Li₃InCl₆, Li₃LaI₆, LiYF₄, LiYbF₄, LiLaF₄, LiBiF₄, LiAlCl₄, or LiGaCl₄, other than Li₃AlF₆. Since Li, S, and O serve respectively as a univalent cation, a quadrivalent or hexavalent cation, and a bivalent anion, either d+4e=2f or d+6e=2f is satisfied. In other words, d+n×e=2f is satisfied, where n is four or six. The above-described compound Li_{d}SₑO_{f} other than Li₂SO₄ may, for example, be Li₂SO₃ (lithium sulfite).

The solid electrolyte 22 made by mixing the compounds LiₐM_{b}X_{c} and Li_{d}SₑO_{f} is expressed by a composition formula of Li_{a+d}M_{b}X_{c}SₑO_{f}. The solid electrolyte 22 also satisfies the conditions described previously, i.e., a+3b=c and d+n×e=2f, where n is four or six. In consideration of measurement errors or the like, 0.8c≤(a+3b)≤1.2c and 1.6f≤(d+n×e)≤2.4f may be satisfied. Preferably, 0.9c≤(a+3b)≤1.1c and 1.8f≤(d+nx e)≤2.2f are satisfied. The solid electrolyte 22 expressed by a composition formula of Li_{a+d}M_{b}X_{c}SₑO_{f} exhibits high lithium-ion conductivity and high temperature stability. In the making of Li₃AlF₆—Li₂SO₄, LiF, AlF₃, and Li₂SO₄ may be mixed together and subjected to a mechanical milling process without generation of Li₃AlF₆.

In the case of checking whether an unknown solid electrolyte is the solid electrolyte 22 expressed by Li_{a+d}M_{b}X_{c}SₑO_{f}, chemical analysis is conducted on the unknown solid electrolyte and it is checked whether the constituent elements of the unknown solid electrolyte include Li, M, X, S, and O. If Li, M, X, S, and O are the constituent elements and if the values a to f in the molar ratio of the constituent elements satisfy 0.8c≤(a+3b)≤1.2c and 1.6f≤(d+n×e)≤2.4f, where n is four or six, it can be said that the unknown solid electrolyte is the solid electrolyte 22 expressed by Li_{a+d}M_{b}X_{c}SₑO_{f}. For example, Li, Al, and S can be quantitated by an ICP emission spectroscope, F can be quantitated by ion chromatography, and O can be quantitated by oxygen/nitrogen gas analysis. In the case where the solid electrolyte contains an element M that is other than Al and an element X that is other than F, a measurement method that can quantitate the elements M and X is selected as appropriate.

The all-solid-state battery 1 described above may be modified in various ways.

The interfacial product 23 may be generated by a method other than the charge operation of the all-solid-state battery 1. In this case, the negative active material 21 may be an active material that operates at a potential of higher than 2.0V (vs. Li/Li⁺). The solid electrolyte 22 may or may not contain O.

The solid electrolyte layer 13 may contain any other substance in addition to the solid electrolyte 22. The solid electrolytes contained in the solid electrolyte layer 13 and the positive electrode 11 may be different from the solid electrolyte 22 contained in the negative electrode 12. The production of the solid electrolyte 22 may be conducted by a technique other than a mechanical milling process.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### REFERENCE SIGNS LIST

1 all-solid-state battery
11 positive electrode
12 negative electrode
13 solid electrolyte layer
21 negative active material
22 solid electrolyte
23 compound (interfacial product)
S11 to S13 step

1. A battery comprising:
a positive electrode;
a negative electrode including a negative active material and a solid electrolyte; and
a solid electrolyte layer provided between said positive electrode and said negative electrode,
wherein said negative electrode includes another compound that exists at an interface between said negative active material and said solid electrolyte, and
said another compound contains Li and O.

2. The battery according to claim 1, wherein
said negative active material is an active material that operates at a potential of less than or equal to 2.0V (vs. Li/Li⁺).

3. The battery according to claim 1, wherein
said negative active material is an active material that operates at a potential of less than or equal to 1.0V (vs. Li/Li⁺).

4. The battery according to claim 1, wherein
said another compound exists as a layer at said interface, and
said another compound has a thickness of 1 nm to 1000 nm.

5. The battery according to claim 1, wherein
said solid electrolyte contains Li and O.

6. The battery according to claim 5, wherein
said solid electrolyte further contains X that is a halogen element.

7. The battery according to claim 5, wherein
said solid electrolyte further contains S.

8. The battery according to claim 5, wherein
said solid electrolyte further contains Al.

9. The battery according to claim 5, wherein
said solid electrolyte contains, as a principal component, a component expressed by a composition formula of Li_{a+d}M_{b}X_{c}SₑO_{f} with values a to f being greater than zero, where M is an element serving as a trivalent cation, and X is a halogen element, and
0.8c≤(a+3b)≤1.2c and 1.6f≤(d+n×e)≤2.4f are satisfied, where n is four or six.

10. The battery according to claim 1, wherein
said another compound does not contain Ti.

11. The battery according to claim 1, wherein
said solid electrolyte contains S, and
said another compound does not contain S.

12. The battery according to claim 1, wherein
said negative active material is carbon.

13. A method of producing the battery according to claim 1, the method comprising:
a) preparing a battery by stacking a positive electrode, a solid electrolyte layer, and a negative electrode that includes a negative active material and a solid electrolyte; and
b) performing a charge operation on said battery,
wherein said solid electrolyte of said negative electrode contains Li and O.

14. A method of producing the battery according to claim 1, the method comprising:
a) preparing a battery by stacking a positive electrode, a solid electrolyte layer, and a negative electrode that includes a negative active material and a solid electrolyte; and
b) performing a charge operation on said battery,
wherein said operation a) is performed in an oxygen-containing atmosphere, and
in said operation b), Li ions migrate from said positive electrode to said negative electrode.
